(19) United States
(12) Patent Application Publication
(10) Pub. No.: US 2026/0109575 A1
(43) Pub. Date: Apr. 23, 2026

(54) CAR LOCK DEVICE AND ELEVATOR SYSTEM

(71) Applicant: Otis Elevator Company, Farmington, CT (US)

(72) Inventor: Bing Li, Shanghai (CN)

(21) Appl. No.: 19/354,274

(22) Filed: Oct. 9, 2025

(30) Foreign Application Priority Data
Oct. 17, 2024 (CN) 202411457472.X

(51) Int. Cl. B66B 5/26

(52) U.S. Cl. CPC B66B 5/26

(57) ABSTRACT

A car lock device and an elevator system. The car lock device is used for the elevator system including an elevator car and guide rails, the car lock device includes a locking unit fixedly connected to the elevator car and at least two paired limiting units fixed on the guide rails, the locking unit including a rotatable locking rod, and the locking unit having a first rotation position and a second rotation position, in the first rotation position, the locking rod is decoupled from the guide rails to ensure the normal operation state of the elevator car, and in the second rotation position, the locking rod can interfere with the paired limiting units and be restricted between the paired limiting units, so that the elevator car cannot operate normally.

### FOREIGN PRIORITY

This application claims priority to Chinese Patent Application No. 202411457472.X, filed Oct. 17, 2024, and all the benefits accruing therefrom under 35 U.S.C. § 119, the contents of which in its entirety are herein incorporated by reference.

### TECHNICAL FIELD OF INVENTION

The present disclosure relates to the field of elevators, and in particular to a car lock device and an elevator system.

### BACKGROUND OF THE INVENTION

This section is intended to provide background information relevant to understanding various technologies described herein. As the title of this section implies, this is a discussion of relevant technologies which should not in any way be implied as necessarily the prior art. Therefore, it should be understood that any statements in this section should be read in this light, and not as any acknowledgement of the prior art.

When implementing home elevator or villa elevator projects, it is difficult to arrange traditional car lock devices in cantilever structures. The car lock device is crucial for the safety of machine maintenance on the top of the car structure (where maintenance personnel stand on the top of the structure to maintain the elevator's main engine), as it can prevent unintended movement of the car. This requirement can also be found in Rules for the Construction and Installation of Home Lifts GB/T21739 in China or the elevator standard EN81-20 issued by the European Committee for Standardization.

### SUMMARY OF THE INVENTION

The purpose of the present disclosure is to solve or at least alleviate the problems existing in the prior art.

According to one aspect, there is provided a car lock device for an elevator system, comprising an elevator car and guide rails, wherein the car lock device comprises a locking unit fixedly connected to the elevator car and at least two paired limiting units fixed on the guide rails, the locking unit comprising a rotatable locking rod, and the locking unit having a first rotation position and a second rotation position, wherein in the first rotation position, the locking rod is decoupled from the guide rails to ensure the normal operation state of the elevator car, and in the second rotation position, the locking rod can interfere with the paired limiting units and be restricted between the paired limiting units, so that the elevator car cannot operate normally.

Optionally, according to an implementation of the present disclosure, the locking unit comprises a supporting seat disposed on a car crossbeam of the elevator car, and the locking rod is rotatably disposed on the supporting seat.

Optionally, according to an implementation of the present disclosure, the locking unit comprises a switch disposed on the supporting seat, the switch has a trigger state and a non-trigger state, and the switch is configured to be in the non-trigger state in the first rotation position, and to be in the trigger state in the second rotation position, and in the trigger state, the switch sends an elevator lock completion signal to an elevator system controller of the elevator system.

Optionally, according to an implementation of the present disclosure, the locking unit comprises a rotating shaft disposed on the supporting seat, and the locking rod is rotatably disposed on the supporting seat via the rotating shaft.

Optionally, according to an implementation of the present disclosure, the locking unit comprises a fastener, wherein in the first rotation position, the locking rod is fixed to the supporting seat via the fastener and the fastener does not trigger the switch, and in the second rotation position, the locking rod is fixed to the supporting seat via the fastener and the fastener triggers the switch.

Optionally, according to an implementation of the present disclosure, the locking unit comprises a rotatable handle rotatably disposed on the supporting seat via the rotating shaft, and the locking unit comprises a fastener, wherein in the first rotation position, the handle is fixed to the supporting seat via the fastener and the fastener does not trigger the switch, and in the second rotation position, the handle is fixed to the supporting seat via the fastener and the fastener triggers the switch.

Optionally, according to an implementation of the present disclosure, a first end of the rotating shaft and the locking rod are configured as one piece.

Optionally, according to an implementation of the present disclosure, the handle is fitted onto a second end of the rotating shaft, the second end being provided with a through-hole, and the locking unit comprises a bolt running through the through-hole.

Optionally, according to an implementation of the present disclosure, the locking unit comprises a stop block disposed on the supporting seat, wherein in the first rotation position, the movement of the handle along a first rotation direction is limited by the stop block, and in the second rotation position, the movement of the handle along a second rotation direction is limited by the stop block.

Optionally, according to an implementation of the present disclosure, the handle is provided with a first opening, a second opening and a third opening, and the handle is fitted onto the rotating shaft through the second opening, wherein in the first rotation position, the fastener fixes the handle via the first opening, and in the second rotation position, the fastener fixes the handle via the third opening.

Optionally, according to an implementation of the present disclosure, the paired limiting unit is configured with a flange, and the flange is provided with a flat surface for interfering with the locking rod.

Optionally, according to an implementation of the present disclosure, the handle and the locking rod are configured in a plate shape, with the width of the handle and the locking rod smaller than the width of the car crossbeam.

Optionally, according to an implementation of the present disclosure, the supporting seat comprises a first supporting plate and a second supporting plate, with the rotating shaft running through the first supporting plate and the second supporting plate, the handle and the stop block being disposed on the outside of the first supporting plate, and the locking rod being disposed on the outside of the second supporting plate.

Optionally, according to an implementation of the present disclosure, a bracket is fixed on the first supporting plate, and the switch is fixed to the bracket.

Optionally, according to an implementation of the present disclosure, in the first rotation position, the handle and the locking rod are arranged vertically, and in the second rotation position, the handle and the locking rod are arranged horizontally.

According to another aspect, there is provided an elevator system, comprising any one of the aforementioned car lock devices.

The car lock device according to the embodiments of the present disclosure can conveniently and quickly switch between a maintenance mode and a normal operation mode and play respective roles in a cost-effective manner. In the maintenance mode, the car lock device is used to limit the position of the elevator car, while in the normal operation mode, the car lock device does not affect the normal operation of the car.

### BRIEF DESCRIPTION OF THE DRAWINGS

The content of the present disclosure will become easier to understand with reference to the drawings. It can be readily appreciated by a person skilled in the art that these drawings are for illustrative purposes only, and are not intended to limit the scope of protection of the present disclosure. In addition, similar numerals in the drawings denote similar components, wherein:

FIG. 1 is a schematic diagram of an exemplary elevator system;

FIG. 2 shows a top view of an elevator system according to the present disclosure;

FIG. 3 shows a three-dimensional view of an elevator system according to the present disclosure;

FIG. 4 shows a partial enlarged view of an elevator system in which a car lock device is in a first rotation position according to the present disclosure;

FIG. 5 shows a side view of a car lock device in a first rotation position toward a handle according to the present disclosure;

FIG. 6 shows a side view of a car lock device in a first rotation position toward a locking rod according to the present disclosure;

FIG. 7 shows a partial enlarged view of an elevator system in which a car lock device is in a second rotation position according to the present disclosure;

FIG. 8 shows a front view of a car lock device in a second rotation position facing a switch according to the present disclosure;

FIG. 9 shows a three-dimensional view of a rotating shaft according to the present disclosure; and

FIG. 10 shows a three-dimensional view of a handle according to the present disclosure.

### DETAILED DESCRIPTION OF THE INVENTION

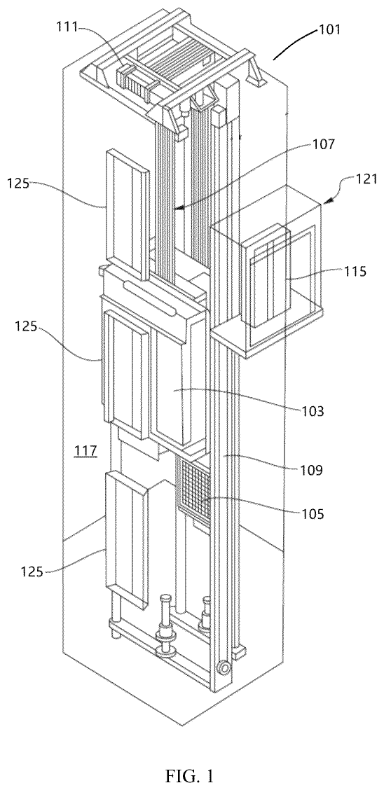

FIG. 1 is a perspective view of an elevator system 101 that includes an elevator car 103, a counterweight 105, ropes 107, guide rails 109, a traction machine 111 and an elevator system controller 115. The elevator car 103 and the counterweight 105 are connected to each other via ropes 107. The ropes 107 may include or be configured as, for example, cords, steel cables and/or a coated steel belt, and in this embodiment, the ropes are configured as a rope belt integrating a plurality of ropes. The counterweight 105 is configured to balance the load of the elevator car 103 and to facilitate synchronized, counter-directional movement of the elevator car 103 relative to the counterweight 105 within an elevator hoistway 117 and along the guide rails 109. The ropes 107 engage with the traction machine 111 which is part of an overhead structure of the elevator system 101. The traction machine 111 is configured to control movement between the elevator car 103 and the counterweight 105.

The elevator system controller 115 as illustrated is positioned within an elevator system controller room 121 of the elevator hoistway 117, and is configured to control operation of the elevator system 101 and in particular the elevator car 103. For example, the elevator system controller 115 may provide a drive signal to the traction machine 111 to control the acceleration, deceleration, leveling, stopping, etc. of the elevator car 103. When moving up or down along the guide rails 109 in the elevator hoistway 117, the elevator car 103 as controlled by the elevator system controller 115 can stop at one or more landings 125. Although the elevator system controller 115 is shown within the elevator system controller room 121, a person skilled in the art will appreciate that the elevator system controller 115 may be located and/or configured at other position or location within the elevator system 101. The traction machine 111 may include a motor or a similar drive mechanism.

Although a rope system has been presented and described, elevator systems that utilize other methods and mechanisms for moving an elevator car within an elevator hoistway may also implement the embodiments of the present disclosure. FIG. 1 is a non-limiting example presented for illustrative and explanatory purposes only.

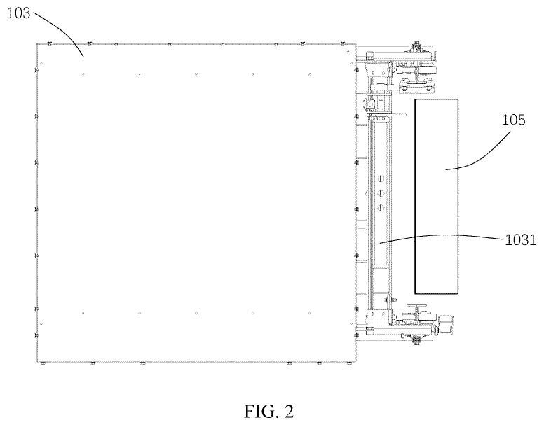

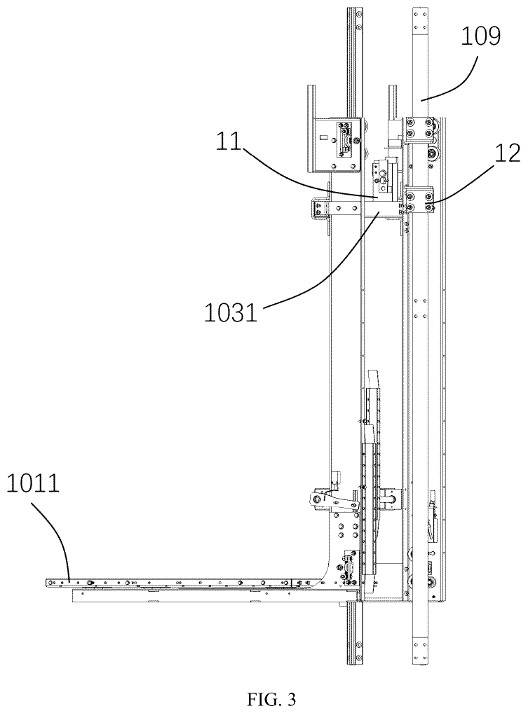

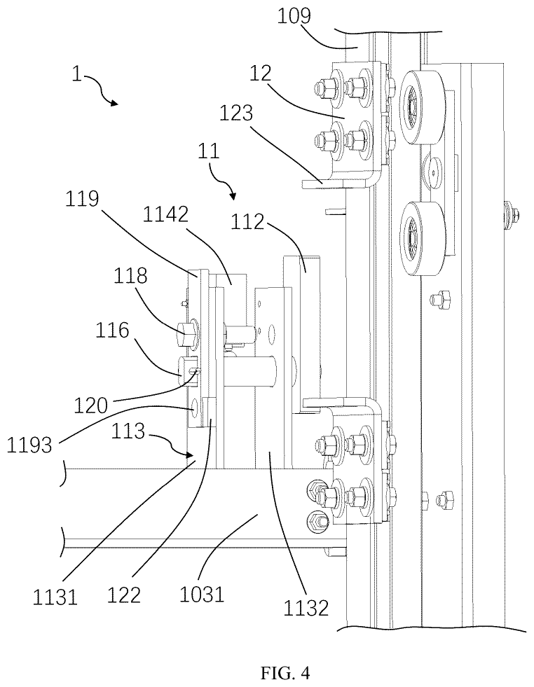

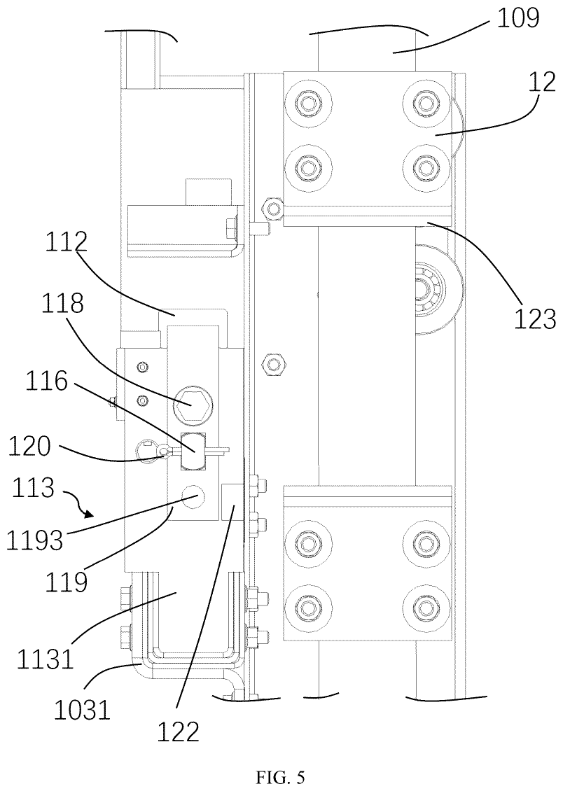

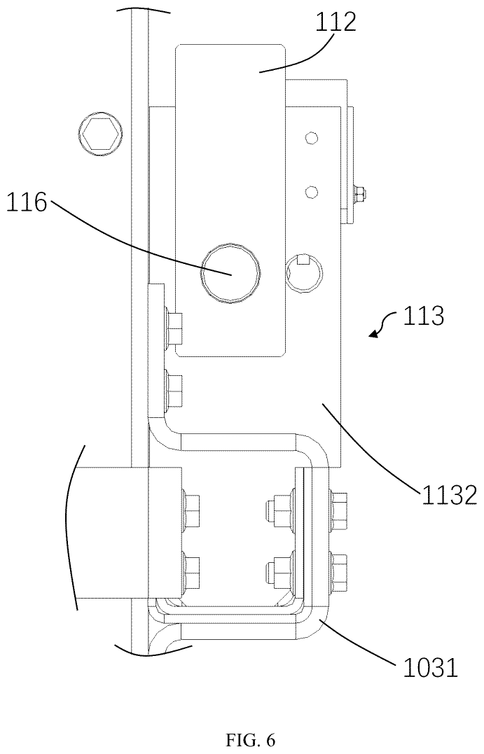

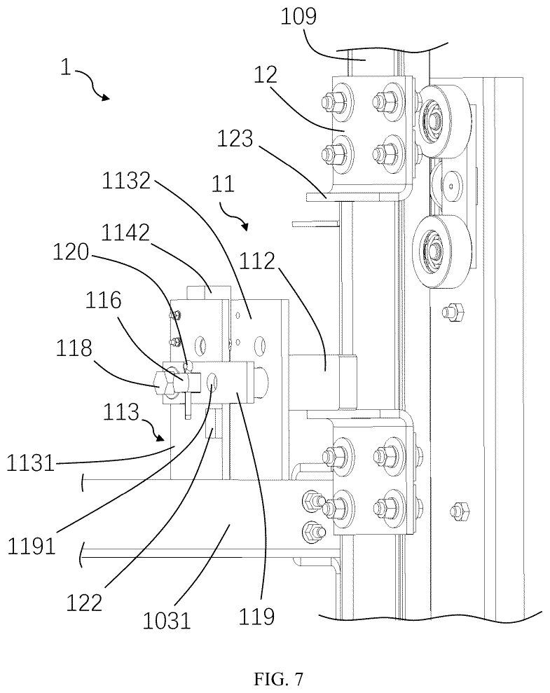

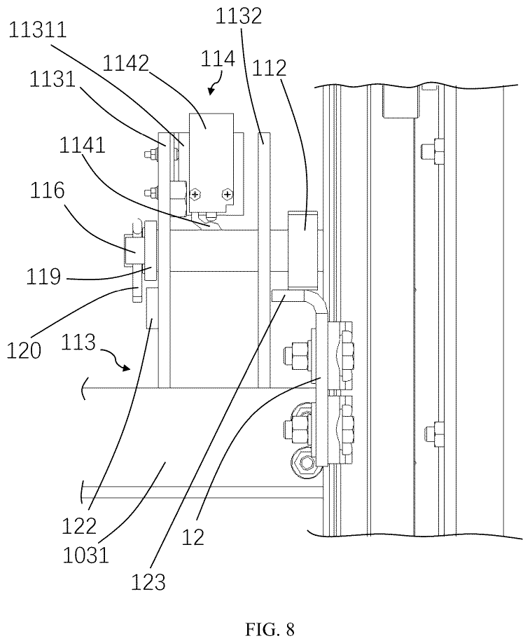

Referring to FIGS. 2 to 8, FIG. 2 shows a top view of an elevator system according to the present disclosure; FIG. 3 shows a three-dimensional view of an elevator system according to the present disclosure; FIG. 4 shows a partial enlarged view of an elevator system in which a car lock device is in a first rotation position according to the present disclosure; FIG. 5 shows a side view of a car lock device in a first rotation position toward a handle according to the present disclosure; FIG. 6 shows a side view of a car lock device in a first rotation position toward a locking rod according to the present disclosure; FIG. 7 shows a partial enlarged view of an elevator system in which a car lock device is in a second rotation position according to the present disclosure; and FIG. 8 shows a front view of a car lock device in a second rotation position facing a switch according to the present disclosure.

The car lock device 1 is used for an elevator system 101. The elevator system 101 comprises an elevator car 103 and guide rails 109, wherein the car lock device 1 comprises a locking unit 11 fixedly connected to the elevator car 103, the locking unit 11 comprising a rotatable locking rod 112, and the locking unit 11 having a first rotation position and a second rotation position, wherein in the first rotation position, the locking rod 112 is decoupled from the guide rails 109 to ensure the normal operation state of the elevator car 103, and in the second rotation position, the locking rod 112 cooperates with the guide rails 109 to limit the position of the elevator car 103, so that the elevator car 103 cannot operate normally.

Therefore, it should be understood that the locking unit of the car lock device has two rotation positions or working states. The first rotation position of the locking unit corresponds to the normal operation state (normal operation mode) of the elevator system and the non-working mode of the car lock device, while the second rotation position of the locking unit corresponds to the abnormal operation state (e.g., maintenance mode) of the elevator system or the working mode of the car lock device. In the first rotation position, the elevator system can operate normally, as the locking rod is decoupled from the guide rails, that is, the locking rod will not interfere with the guide rails during the operation of the elevator car. In the second rotation position, the locking rod can easily and quickly cooperate with the guide rails (including components on the guide rails) through rotational movement, so as to directly or indirectly limit the position of the elevator car. Herein, such position limitation includes restricting the elevator car within a certain space or range of activity, and also includes the means of locking the elevator car in a specific position.

It can also be understood that the car lock device of the present disclosure can be used in various elevator systems, including an elevator system based on a gantry frame, or a backpack-frame-type (or cantilever-structure-type) elevator system. Among them, the cantilever-structure-type (also referred to as backpack-frame-type) elevator system can be well understood in view of FIG. 3: the elevator car is disposed on one side of the guide rails, and forms a supporting structure in a cantilever form with a supporting platform 1011 below. The gantry frame structure resembles a box-like structure with handles, featuring multiple force bearing points. Typically, there is a guide rail on each side of the elevator car, along with a force bearing platform at the bottom for support.

In addition, the present disclosure describes the car lock device mainly using a rotary mechanical structure. Although not described in detail in the present disclosure, other structural forms such as an electromagnetic lock form (using electromagnetic force to control the rotation of the locking rod), a hydraulic or pneumatic lock form, or a combination of the above forms may also be applicable. Exemplarily, in the second rotation position, the locking rod 112 clamps the guide rails 109, that is, such locking is based on a holding brake locking type. To this end, the locking unit may also be configured with a power device to provide power to the locking rod. In this configuration, fixing the elevator car relative to the guide rails through clamping force results in a better position-limiting effect without requiring additional design to the guide rails, thus enhancing compatibility. It can also be understood that multiple groups of car lock devices or locking units can be configured to limit the position of the elevator car more comprehensively and evenly.

According to this technical solution, the car lock device can limit the position of the elevator car under particular circumstances (for example, during emergency braking, repair or maintenance) through rotational movement of the locking rod in cooperation with the guide rails, thereby preventing unintended movement of the car in a convenient and quick manner, and improving the safety of the elevator system.

Regarding the specific method of cooperation with the guide rails, exemplarily, the car lock device 1 comprises at least two paired limiting units 12 fixed on the guide rails 109. In the second rotation position, the locking rod 112 can interfere with the paired limiting units 12 and be restricted between the paired limiting units 12.

In other words, the elevator car can be limited in position as needed by means of the paired limiting units configured on the guide rails cooperating with the locking rod. To this end, there may be a plurality of, for example, two, paired limiting units, which are arranged at certain spacing. The spacing corresponds to the range of restricted movement of the elevator car in the maintenance mode of the elevator system. It can be understood that the spacing is greater than the width or height of the locking rod, so that the locking rod can smoothly engage with this spacing. The paired limiting units can be clamped and fixed onto an end face of the guide rails in the form of fixed blocks, so that the arrangement of the paired limiting units will not affect the cooperative relationship between the guide rails and pulleys, thereby not interfering with the normal function of the guide rails. It can also be understood that the fixed arrangement of the paired limiting units relative to the guide rails (for example, each paired limiting unit is fixed by four sets of threaded fasteners) can provide a more stable position-limiting effect for the elevator car. On the other hand, the position of the paired limiting unit on the guide rails can be purposefully designed to limit the maintenance position of the elevator car in the maintenance mode as needed, that is, to control the maintenance position of the car, which is crucial for safe operation in repair, maintenance or emergency situations.

To achieve the cooperative function of the locking rod with the paired limiting units, allowing the locking rod to smoothly enter between the paired limiting units at the second rotation position, a person skilled in the art should understand that the spacing between two adjacent paired limiting units (such as the fixing positions of two adjacent paired limiting units on the guide rails) and/or the length of the locking rod can be adaptively designed or adjusted. For instance, the spacing between the two adjacent paired limiting units along the longitudinal direction of the guide rails is greater than the length of the locking rod, so that the locking rod can rotate smoothly between the paired limiting units when transitioning from the first rotation position to the second rotation position, thereby limiting the position of the elevator car.

It can also be understood that, as will be described hereinafter, although the first rotation position is presented in the vertical direction of the handle and the locking rod (parallel to the guide rail direction and the hoistway height direction), and the second rotation position is presented in the horizontal direction of the handle and the locking rod (perpendicular to the guide rail direction and transverse to the hoistway height direction) in the drawings, the directions of the first rotation position and the second rotation position are not limited thereto. For example, oblique directions are also feasible, as long as the locking rod is decoupled from the guide rails in the first rotation position, and the locking rod forms an interfering cooperation with the paired limiting unit in the second rotation position.

Referring to FIG. 2, there is a limited space problem particularly for the cantilever elevator system. For example, the distance between the car crossbeam, the counterweight and the rail bracket may be very close, making it difficult to arrange a traditional car lock device.

To this end, in some embodiments of the present disclosure, the locking unit 11 comprises a supporting seat 113 disposed on the car crossbeam 1031 of the elevator car 103, and the locking rod 112 is rotatably disposed on the supporting seat 113.

It can be understood that during normal operation of the car, the crossbeam moves up and down together with the car, and the locking unit is disposed on the car crossbeam. As such, limiting the position of the car can be indirectly achieved by limiting the position of the locking unit. Depending on the different design of the car, the car crossbeam may be an upper crossbeam, and is disposed on the back side of the elevator car together with the locking unit.

According to this technical solution, the design of the supporting seat provides solid support for the locking rod, and also serves as a foundation for the rotation and fixation of the locking rod. The supporting seat may be configured, for example, as a one-piece block or as shown in the figure, composed of several plates. This design enhances the overall stability of the locking unit, ensuring that the locking unit can work stably during elevator maintenance and is not easily loosened or failed due to external forces. This design also clarifies and secures the installation position of the locking unit, enabling installers to complete the installation work quickly and accurately. At the same time, such design also facilitates subsequent maintenance and overhaul work, reducing maintenance costs. In addition, as mentioned above, since the locking unit is disposed on the crossbeam, it does not occupy any additional space, or it occupies very little space, of the car's crossbeam, counterweight, and rail bracket, resulting in high compactness. The supporting seat is disposed, for example, close to the guide rails or the paired limiting unit so that the locking rod can approach the guide rails more easily. In addition, the present disclosure does not impose any specific limitation on the number of components. For example, one locking unit can be disposed at both ends of the crossbeam respectively to achieve the effect of force distribution and force balance when limiting the position of the car, thereby enhancing the service life of the car lock device as a whole.

In order to verify whether the rotation position or state of the locking unit is in place, the locking unit 11 comprises a switch 114 disposed on the supporting seat 113, and the switch 114 has a trigger state and a non-trigger state. The switch 114 is configured to be in the non-trigger state in the first rotation position and in the trigger state in the second rotation position. In the trigger state, the switch 114 sends an elevator lock completion signal to the elevator system controller 115 of the elevator system 101.

It follows that with the design of the switch, after the locking unit reaches the second rotation position and can realize the position-limiting function (for example, the locking rod is fixed), the switch can be triggered or activated to send a signal indicating that the elevator has been locked, thus allowing maintenance personnel to proceed with the maintenance work. This real-time monitoring and feedback mechanism helps to ensure safety of the elevator in the locked state, and prevent safety accidents caused by inadequate locking. The signal may be in various forms such as a text signal, a visual signal, an auditory signal or a combination of signals. At the same time, the arrangement of the switch utilizes the space provided by the supporting seat, thereby not occupying any additional space. The supporting seat also performs functions such as fixing and rotating the locking rod as well as arranging the switch; other functions will be described later.

In some embodiments of the present disclosure, the locking unit 11 comprises a rotating shaft 116 disposed on the supporting seat 113, and the locking rod 112 is rotatably disposed on the supporting seat 113 via the rotating shaft 116.

The rotating shaft serves as a foundation for the rotational movement of the locking rod, and the locking rod may also be disposed on the supporting seat via the rotating shaft, having dual functions. To this end, the supporting seat may be configured with a through-hole for rotatably accommodating the rotating shaft. The rotating shaft and the hole are, for example, circular, which facilitates the implementation of the rotational movement and is easy to manufacture with controllable costs.

Regarding the specific linkage mechanism of the switch, in some embodiments of the present disclosure, the locking unit 11 comprises a fastener 118. In the first rotation position, the locking rod 112 is fixed to the supporting seat 113 via the fastener 118 and the fastener 118 does not trigger the switch 114. In the second rotation position, the locking rod 112 is fixed to the supporting seat 113 via the fastener 118 and the fastener 118 triggers the switch 114.

Among them, the fastener is, for example, a combination of bolts, screws and nuts, or in the form of bolt, clipping and the like. The switch is triggered by the fastener, that is, the switch is activated after the locking rod is fixed. As such, the fastener has dual functions of fixing and triggering, and ensures the safety of limiting the position of the entire device, as well as simplifies the structure and reduces the cost. To this end, the locking rod and the supporting seat can be provided with through-holes accordingly for the fastener to run through. It can also be seen that in the first rotation position, the fastener does not trigger the switch, and in the second rotation position, the fastener triggers the switch. Therefore, it can be understood that the fastener has different fixing positions in these two rotation positions, which can be realized, for example, by disposing the through-hole for the fastener to run through in a non-rotational central position. It can also be understood that in these two rotation positions, the locking rod can be fixed by the same fastener, which is cost-effective.

The present disclosure does not impose any limitation on the structural form of the switch, including a mechanical contact switch, a magnetic induction switch (Hall effect), a micro switch, a photoelectric switch, an inductive proximity switch, etc. that can be selected as needed. For example, the switch can be determined according to particular requirements and safety standards of the elevator system. In this embodiment, a mechanical contact switch is described as an example. Specifically, the switch comprises a contact 1141 capable of interacting with the fastener and a switch body 1142 capable of interacting with the contact. In the second rotation position, the fastener fixes the locking rod and can apply a force to the contact, so that the contact originally spaced apart from the switch body is subjected to the force and contacts the switch body, thereby triggering or activating the switch. In contrast, when the fastener is not in contact with the contact, the contact can be disengaged from the switch body, thereby restoring the switch to an initial non-trigger state. This form of design can achieve relatively accurate triggering of the switch while also having certain compactness and reliability. To this end, it should be noted that appropriately designing the layout or relative positional relationship of the switch, including its contact and fastener fixing positions, enables the realization of the aforementioned triggering process.

In sum, it can be seen that the design of the locking rod of the locking unit makes it possible to conveniently and quickly limit the position of the car in a cost-effective manner. Additionally, it occupies a small space and is easy for maintenance. In some other embodiments of the present disclosure, the locking unit 11 comprises a rotatable handle 119 which is rotatably disposed on the supporting seat 113 via the rotating shaft 116, and the locking unit 11 comprises a fastener 118. In the first rotation position, the handle 119 is fixed to the supporting seat 113 via the fastener 118 and the fastener 118 does not trigger the switch 114. In the second rotation position, the handle 119 is fixed to the supporting seat 113 via the fastener 118 and the fastener 118 triggers the switch 114.

Therefore, this technical solution realizes the control of the locking rod by controlling the handle, thereby limiting the position of the elevator car. As such, the fastener can fix the locking rod by fixing the handle. Compared with the technical solution of eliminating the handle and only arranging a locking rod, the linkage scheme of the handle and the locking rod allows maintenance personnel to more easily access and operate the handle without requiring a major structural design of the locking rod itself (for example, not requiring providing a through-hole for the fastener to run through), thereby maintaining the strength of the locking rod for subsequent cooperation with the guide rails or the paired limiting unit. In addition, the handle and the locking rod sharing the same rotating shaft enables the handle to easily perform corresponding manipulation of the locking rod, thereby realizing the convenience of the interaction and also providing support to the handle and the locking rod at the supporting seat. The maintenance personnel can switch the locking unit between the first and second rotation positions simply by turning the handle, without additional tools or complicated steps. This simplified operation process improves the using experience and work efficiency. The rotating shaft also ensures the stability and reliability of the handle and the locking rod during rotation, preventing potential safety hazards caused by poor rotation or looseness. In addition, the description and effects of the fastener and switch can be interpreted by drawing an analogy to the description of the previously mentioned solution, and will not be repeated here. It should also be noted that the locking unit has a first rotation position and a second rotation position. Therefore, in the first rotation position or the second rotation position, it can be understood that the handle and the locking rod have a corresponding first rotational state and a corresponding second rotational state, respectively.

In this regard, a first end of the rotating shaft 116 (i.e., the end connected to the locking rod, which is the right end in FIG. 4) and the locking rod 112 are configured as one piece. Thus, the rotating shaft and the locking rod are always in a state of being fixedly connected to each other, so that the rotational control and fixation of the locking rod can be achieved by just controlling and fixing the handle on one side of the handle. The integrated design can reduce the steps and number of components required for separately installing the locking rod in the traditional design, which helps to reduce production costs and simplify the assembly process. It can reduce the risk of failure due to loose or worn connectors, improve the reliability and durability of the entire structure, and reduce the connection points and gap between the rotating shaft and the locking rod, thereby enhancing the compactness and stability of the entire structure. Finally, energy loss and friction loss in the transmission process are also reduced, improving transmission efficiency.

Exemplarily, the one-piece forming method may be welding, which is advantageous in enhancing structural strength and stability, as well as improving production efficiency, cost, product quality, adaptability, energy conservation and environmental protection. In addition, integration can also be achieved through methods such as screwing, riveting, bonding, casting and forging.

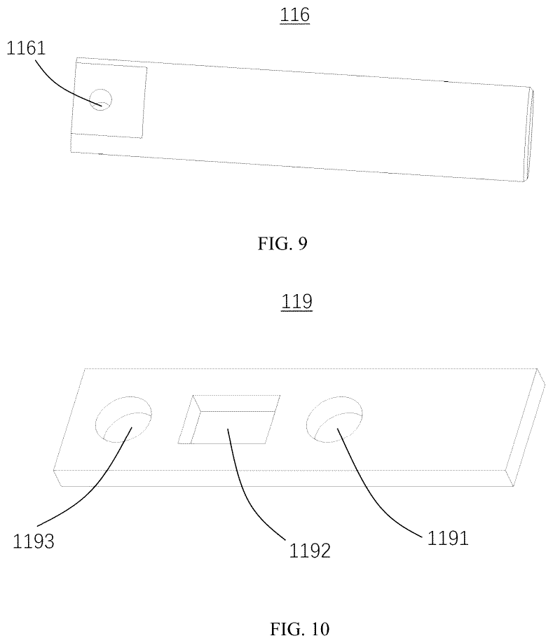

In contrast, on one side of the handle, referring to FIG. 9 which shows a three-dimensional view of a rotating shaft according to the present disclosure, the handle 119 is fitted onto a second end of the rotating shaft 116 (the end connected to the handle, which is the left end in FIG. 4 and FIG. 9), the second end being provided with a through-hole 1161. The locking unit 11 comprises a bolt 120 running through the through-hole 1161.

To this end, the second end of the rotating shaft can be configured into a relatively flat shape, for example, being cut into a rectangular structure to facilitate the fitting of the handle, and this fitting type of connection allows for better maintenance of the relative positional relationship between the handle and the rotating shaft. Apart from that, this technical solution also involves the design of a position-limiting function realized through a bolt. On the one hand, it can achieve horizontal position limitation to prevent falling off, that is, prevent the handle from loosening or disengaging from the rotating shaft due to forces during operation, thereby establishing a secure mechanical connection. On the other hand, it can also maintain the horizontal position of the rotating shaft. Thus, the bolt design has dual functions. The improvement of the overall stability of this structure is particularly important for application scenarios that require withstanding relatively great forces or frequent operations. In addition, the bolt connection is a removable design that makes the installation and removal of the handle convenient and quick, facilitating the maintenance and replacement of components. In addition to the fitting method or as a supplement to it, methods such as welding, bonding and buckling as previously mentioned can also be employed.

In order to limit the rotation range of the handle to prevent the handle or the locking rod from moving to an undesired or meaningless position, in some embodiments of the present disclosure, the locking unit 11 comprises a stop block 122. The stop block 122 is disposed on the supporting seat 113, for example, the end face of the supporting seat facing the handle. In the first rotation position, the movement of the handle 119 along a first rotation direction is limited by the stop block 122, and in the second rotation position, the movement of the handle 119 along a second rotation direction is limited by the stop block 122.

Thus, the handle can be limited to two rotational limit positions by the design of the same stop block. To this end, it can be understood that in the first rotation position, further rotation of the handle (for example, viewed from left to right based on FIG. 4) in the counterclockwise direction will be restricted, in the manner of a first portion of the handle (for example, the lower right portion) abutting against the stop block; in the second rotation position, further rotation of the handle (for example, viewed from left to right based on FIG. 7) in the clockwise direction will be restricted, in the manner of a second portion of the handle (for example, the lower central portion) abutting against the stop block.

It should also be understood that the limiting effect of the stop block does not necessarily mean that the handle will be blocked by the stop block when it makes further rotational movement in the first or second rotation position, but it allows for movement in a certain small amplitude before being blocked. Such small amplitude movement will not have a substantial impact, and it can allow a certain gap between the handle and the stop block in these two rotation positions, thereby facilitating the layout of the handle and the stop block. Therefore, through the design of the stop block, in the first rotation position (i.e., the normal operation mode of the elevator system or the non-working mode of the car lock device), the handle and the locking rod can move to the predetermined position defined by the stop block without affecting the operation of the hoistway area or the guide rails. In the second rotation position (i.e., the maintenance mode of the elevator system or the working mode of the car lock device), the handle and the locking rod can rotate to the expected position to effectively cooperate with the paired limiting units and fulfill the position-limiting function. That is, the stop block makes it easier to control the position of the handle and the locking rod.

Therefore, due to the presence of the stop block, maintenance personnel do not need to be overly cautious when operating the handle, nor do they have to worry about over-rotation or under-rotation. Furthermore, upon hearing the impact sound generated by the contact between the handle and the stop block, which serves as a clear auditory feedback or operation feedback, they can be assured that the handle and the locking rod have rotated to the expected position. This simplifies the operation of the handle while maintaining accuracy, improving operational efficiency, and reducing preparation time and maintenance costs.

Where necessary, considering position-limiting redundancy, a stop block may also be configured in a similar way on the other side of the supporting seat, such as the end face of the supporting seat facing the locking rod, serving as an insurance measure for limiting the position of the locking rod. Alternatively, multiple stop blocks may be arranged at different positions of the end face to help distribute the force. The stop block is exemplarily designed in a rectangular shape, which can achieve the aforementioned various technical effects while being cost-effectiveness and easy to manufacture.

Referring to FIG. 10, a three-dimensional view of a handle according to the present disclosure is shown.

The handle 119 is provided with a first opening 1191, a second opening 1192 and a third opening 1193. The handle 119 is fitted onto the rotating shaft 116 through the second opening 1192. In the first rotation position, the fastener 118 fixes the handle 119 via the first opening 1191. In the second rotation position, the fastener 118 fixes the handle 119 via the third opening 1193.

The specific shapes of these three openings can be designed according to the components to be matched. For example, the first and third openings are configured as circles to better match threaded fasteners, while the second opening is configured as a rectangle to match the shape of the end of the rotating shaft and maintain the relative positional relationship between the two. It can also be seen that, in the first or second rotation position, the fastener engages with the first and third openings respectively and fixes the handle. Therefore, the same fastener realizes fixation in two different rotation positions at different fixing positions, thereby enhancing the flexibility of fixing the handle. Maintenance personnel can select a more suitable opening to engage with the fastener, so as to realize customized design according to different application scenarios and requirements, and enable a more compact design of the supporting seat, or in other words, control the size of the supporting seat and the handle. In addition, as noted before, by fixing the handle, it is possible to eliminate the need to directly create an opening for fixing the locking rod, so that the locking rod has a higher strength to perform the position-limiting function more securely with the paired limiting unit.

It is also feasible that the handle 119 and the locking rod 112 are configured in a plate shape, with the width of the handle 119 and the locking rod 112 smaller than the width of the car crossbeam 1031. In other words, in the first rotation position, the handle 119 and the locking rod 112 are covered by the car crossbeam 1031, as seen in the height direction of the elevator system 101.

In other words, as seen in the height direction of the elevator system, the projections of the handle and the locking rod are located within the car crossbeam, such as the car upper crossbeam. Therefore, in the non-working mode of the locking unit, the handle and the locking rod can be said to be hidden or stored in an area of the car crossbeam to a certain extent, thus not occupying any additional space in the area of the crossbeam, counterweight, guide rails, car or hoistway, and also not affecting the normal operation of these components. This design features high compactness, which helps to optimize space utilization. In addition, the plate-shaped design offers good operability while maintaining low costs, and it can easily cooperate with the paired limiting unit. Likewise, the size of the supporting seat may also be configured to correspond to the width of the car crossbeam. In the case where the car crossbeam is a recessed beam, the supporting seat, for example the lower part thereof, can be configured in the recessed space of the recessed beam, and the main body of the supporting seat laps over a lateral side of the recessed beam (FIG. 5), so as to improve the force bearing capability during the position-limiting operation while fully utilizing the existing space. In addition, considering that the locking rod will be subjected to a great position-limiting force, the locking rod can be configured to be larger or thicker than the handle to improve strength.

In some embodiments of the present disclosure, in the first rotation position, the handle 119 and the locking rod 112 are arranged vertically, and in the second rotation position, the handle 119 and the locking rod 112 are arranged horizontally.

Among them, vertical arrangement can also be understood as arrangement along the lifting direction or height direction of the elevator system, that is, arrangement along the height direction of the hoistway or parallel to the guide rails. Correspondingly, horizontal arrangement can also be understood as arrangement perpendicular to the guide rails or transverse to the height direction of the hoistway. A person skilled in the art should appreciate that the expressions such as vertical or horizontal herein are not strictly vertical or horizontal, but should be understood in a broad sense, for example, vertical or horizontal layout with a certain amount of error or tolerance is allowed, or that can be deviated from within an appropriate range.

Therefore, in this direction, the plate-shaped handle and locking rod occupies relatively little space in the transverse direction, and will not affect the normal operation of the elevator system, in particular will not interfere with the components in the hoistway. In the second rotation position, the horizontal arrangement of the handle and the locking rod facilitates a larger area of position-limiting cooperation with the paired limiting unit, enhancing the force bearing capability and stability under position-limiting conditions. In addition, such explicit arrangement method (vertical or horizontal) provides operators with intuitionistic operating instructions, facilitating quick and efficient operation.

It can also be well seen from FIG. 4 that the paired limiting unit 12 is configured with a flange 123, and the flange 123 is provided with a flat surface for interfering with the locking rod 112. The flat surface is, for example, a horizontal surface. Correspondingly, the matching surface of the locking rod of the locking unit in the second rotation position may also be a horizontal surface, so that the cooperation between the two can have a greater force bearing capability, rendering more stable position limitation. The arrangement of the paired limiting unit across the guide rails can also result in a greater flat surface length or force bearing area as much as possible, further improving the force bearing capability. In addition, the surface contact method can also disperse pressure, reduce wear, and extend the service life of the paired limiting unit and the locking rod, and the noise generated during the position-limiting process will also be relatively low. Of course, other method of cooperation, such as designing the paired limiting unit with a position-limiting column or a convex border, may also be applicable.

Regarding the specific design of the supporting seat, exemplarily, the supporting seat 113 comprises a first supporting plate 1131 and a second supporting plate 1132, with the rotating shaft 116 running through the first supporting plate 1131 and the second supporting plate 1132, the handle 119 and the stop block 122 being disposed on the outside of the first supporting plate 1131, and the locking rod 112 being disposed on the outside of the second supporting plate 1132.

Compared with a single block of the supporting seat structure, this example provides a form of constructing the supporting seat with two supporting plates, which can provide more space for arrangement while controlling costs. For example, the arrangement for the switch achieves a compact structure of the supporting seat, and the layout of the handle and the stop block on the outside of the corresponding supporting plate also facilitates the operator's handling of the handle and the locking rod's contact with the guide rails, making maintenance and replacement of both components easier. Furthermore, as noted before, the lower part of each supporting plate can be configured in the recessed space of the recessed beam, and the main body of each supporting plate laps over a lateral side of the recessed beam (FIG. 5), so as to improve the force bearing capability during the position-limiting operation while fully utilizing the existing space.

In addition, a double-layer supporting structure is formed by a combination of the first supporting plate and the second supporting plate. This design ensures the strength and rigidity of the supporting seat, enabling it to withstand greater loads and impact forces, and improve the stability of the overall structure.

As noted before, the design of the two supporting plates provides internal accommodation space. In this regard, in some embodiments, a bracket 11311 is fixed on the first supporting plate 1131, and the switch 114 is fixed to the bracket 11311.

More specifically, the bracket is configured, for example, as an L-shaped bracket, with the bottom edge of the L-shaped bracket fixedly connected to the inner face of the first supporting plate, and the lateral side of the L-shaped bracket used for fixing and installing the switch. This technical solution fully utilizes the existing internal space between the supporting plates, and the switch can thus smoothly cooperate with the fastener without having to arrange the switch in other positions, so that the switch can function as a part of the locking unit. In addition, the switch disposed on the same side of the first supporting plate or the handle also facilitates subsequent maintenance and repair work, and the maintenance personnel can easily check the status of the switch and make necessary replacement or adjustment. In some other implementations, the bracket may also be connected to the first supporting plate and the second supporting plate at the same time to provide a more stable fixing effect.

In sum, when entering the maintenance mode, the fastener is dismounted from the vertically arranged handle or locking rod, and the handle or locking rod is rotated to reach a horizontal position, with the same fastener screwed into the handle or locking rod for fixing. During this period, the fastener will come into contact with the switch contact and cause the contact to move and touch the switch body, thereby activating the switch and completing the locking process for the elevator. At this point, the position of the locking rod is limited between the paired limiting units, thus limiting the position of the elevator car.

According to another aspect of the present disclosure, the present disclosure further relates to an elevator system 101, wherein the elevator system 101 comprises any one of the aforementioned car lock devices 1. Therefore, the elevator system of the present disclosure can incorporate various implementations and corresponding technical effects of the car lock device, which will not be repeated here.

The specific embodiments of the present disclosure as described above are only for the purpose of describing the principles of the present disclosure more clearly, wherein various components are clearly shown or described to make the principles of the present disclosure easier to understand. A person skilled in the art can easily make various modifications or changes to the present disclosure without departing from the scope of the present disclosure. Therefore, it should be understood that these modifications or changes should fall within the patent protection scope of the present disclosure.

What is claimed is:

1. A car lock device (1) for an elevator system (101), comprising an elevator car (103) and guide rails (109), wherein the car lock device (1) comprises a locking unit (11) fixedly connected to the elevator car (103) and at least two paired limiting units (12) fixed on the guide rails (109), the locking unit (11) comprising a rotatable locking rod (112), and the locking unit (11) having a first rotation position and a second rotation position, wherein in the first rotation position, the locking rod (112) is decoupled from the guide rails (109) to ensure the normal operation state of the elevator car (103), and in the second rotation position, the locking rod (112) can interfere with the paired limiting units (12) and be restricted between the paired limiting units (12), so that the elevator car (103) cannot operate normally.

2. The car lock device (1) according to claim 1, wherein the locking unit (11) comprises a supporting seat (113) disposed on a car crossbeam (1031) of the elevator car (103), and the locking rod (112) is rotatably disposed on the supporting seat (113).

3. The car lock device (1) according to claim 2, wherein the locking unit (11) comprises a switch (114) disposed on the supporting seat (113), the switch (114) has a trigger state and a non-trigger state, and the switch (114) is configured to be in the non-trigger state in the first rotation position, and to be in the trigger state in the second rotation position, and in the trigger state, the switch (114) sends an elevator lock completion signal to an elevator system controller (115) of the elevator system (101).

4. The car lock device (1) according to claim 3, wherein the locking unit (11) comprises a rotating shaft (116) disposed on the supporting seat (113), and the locking rod (112) is rotatably disposed on the supporting seat (113) via the rotating shaft (116).

5. The car lock device (1) according to claim 3, wherein the locking unit (11) comprises a fastener (118), wherein in the first rotation position, the locking rod (112) is fixed to the supporting seat (113) via the fastener (118) and the fastener (118) does not trigger the switch (114), and in the second rotation position, the locking rod (112) is fixed to the supporting seat (113) via the fastener (118) and the fastener (118) triggers the switch (114).

6. The car lock device (1) according to claim 4, wherein the locking unit (11) comprises a rotatable handle (119) rotatably disposed on the supporting seat (113) via the rotating shaft (116), and the locking unit (11) comprises a fastener (118), wherein in the first rotation position, the handle (119) is fixed to the supporting seat (113) via the fastener (118) and the fastener (118) does not trigger the switch (114), and in the second rotation position, the handle (119) is fixed to the supporting seat (113) via the fastener (118) and the fastener (118) triggers the switch (114).

7. The car lock device (1) according to claim 6, wherein a first end of the rotating shaft (116) and the locking rod (112) are configured as one piece.

8. The car lock device (1) according to claim 6, wherein the handle (119) is fitted onto a second end of the rotating shaft (116), the second end being provided with a through-hole (1161), and the locking unit (11) comprises a bolt (120) running through the through-hole (1161).

9. The car lock device (1) according to claim 6, wherein the locking unit (11) comprises a stop block (122) disposed on the supporting seat (113), wherein in the first rotation position, the movement of the handle (119) along a first rotation direction is limited by the stop block (122), and in the second rotation position, the movement of the handle (119) along a second rotation direction is limited by the stop block (122).

10. The car lock device (1) according to claim 6, wherein the handle (119) is provided with a first opening (1191), a second opening (1192) and a third opening (1193), and the handle (119) is fitted onto the rotating shaft (116) through the second opening (1192), wherein in the first rotation position, the fastener (118) fixes the handle (119) via the first opening (1191), and in the second rotation position, the fastener (118) fixes the handle (119) via the third opening (1193).

11. The car lock device (1) according to claim 1, wherein the paired limiting unit (12) is configured with a flange (123), and the flange (123) is provided with a flat surface for interfering with the locking rod (112).

12. The car lock device (1) according to claim 6, wherein the handle (119) and the locking rod (112) are configured in a plate shape, with the width of the handle (119) and the locking rod (112) smaller than the width of the car crossbeam (1031).

13. The car lock device (1) according to claim 9, wherein the supporting seat (113) comprises a first supporting plate (1131) and a second supporting plate (1132), with the rotating shaft (116) running through the first supporting plate (1131) and the second supporting plate (1132), the handle (119) and the stop block (122) being disposed on the outside of the first supporting plate (1131), and the locking rod (112) being disposed on the outside of the second supporting plate (1132).

14. The car lock device (1) according to claim 13, wherein a bracket (11311) is fixed on the first supporting plate (1131), and the switch (114) is fixed to the bracket (11311).

15. The car lock device (1) according to claim 12, wherein in the first rotation position, the handle (119) and the locking rod (112) are arranged vertically, and in the second rotation position, the handle (119) and the locking rod (112) are arranged horizontally.

16. An elevator system (101), comprising the car lock device (1) according to claim 1.
